(19) United States
(12) Patent Application Publication
(10) Pub. No.: US 2014/0051101 A1
(43) Pub. Date: Feb. 20, 2014

(54) Luciferase Reporter System for Roots and Methods of Using the Same

(71) Applicant: Carnegie Institution of Washington, Washington, DC (US)

(72) Inventor: Jose R. Dinneny, Washington, DC (US)

(73) Assignee: Carnegie Institution of Washington, Washington, DC (US)

(21) Appl. No.: 13/970,960

(22) Filed: Aug. 20, 2013

Related U.S. Application Data
(60) Provisional application No. 61/684,938, filed on Aug. 20, 2012.

(51) Int. Cl. G01N 21/76

(52) U.S. Cl. CPC G01N 21/763
USPC 435/8; 435/419; 435/289.1; 435/288.7

(57) ABSTRACT

The present invention relates to a systems and methods of using expression of one or two luminescent proteins in a plant root cell to visualize plant root structure as well as to determine how stressors affect gene expression in plant roots while maintaining the natural soil habitat

### BACKGROUND OF THE INVENTION

### Field of the Invention

The present invention relates to a systems and methods of using expression of one or two luminescent proteins in a plant root cell to visualize plant root structure as well as to determine how stressors affect gene expression in plant roots while maintaining the natural soil habitat.

### BACKGROUND OF THE INVENTION

Plants respond to environmental stressors primarily though a change or changes in gene expression. In response to a stressor, a cell will upregulate certain genes and downregulate others, changing the profile of proteins expressed in an attempt by the cell to cope with the changes signaled by the stressor.

One of the main organs of a plant is the root system, which, among other tasks, absorbs water and nutrients to distribute throughout a plant. It is therefore of significant importance to understand how these vital pathways function. Root biology has recently seen a renaissance due to the development of methodologies that enable high-resolution spatial and temporal analysis of biological pathways using imaging and genomic tools. Despite these advances, an understanding of root development and physiology in the natural soil context is still severely limited.

Soil is a complex matrix that precludes many of the light-based imaging techniques pioneered in the last two decades. As a consequence, alternative growth systems such as those that rely upon solidified gelling agents have become wide spread even though they have limited similarity to the environment roots typically grow in. A few methods for studying root structures in soil have been pioneered, such as X-ray tomography and Magnetic Resonance Imaging (MRI). These methods enable high-resolution visualization of the root and soil particles in small samples but utilize expensive equipment, which is unavailable to most research labs. Furthermore, these systems are currently unable to resolve structures as thin as Arabidopsis roots.

Knowledge of the transcriptional programs underlying root development and environmental response has rapidly increased in the past 5 years. This knowledge can now be applied to understanding root biology in the soil context. Currently no system exists that provides researchers with the visualization tools necessary for high-resolution spatial and temporal studies.

The inventions described herein provide help to understand the growth, physiology and gene expression patterns of roots grown in soil. Plants, after all, live a dual life. While the shoot reaches up to gather light and fix carbon from the atmosphere, the root navigates through a dark and mysterious underworld filled with environmental variation unparalleled above ground. Often dubbed, the “hidden half”, roots are shrouded in a veil of soil that hinders the use of many current methods of visualization and analysis (Trachsel, S., Kaeppler, S. M., Brown, K. M. and Lynch, J. P. (2011) ‘Shovelomics: high throughput phenotyping of maize (Zea mays L.) root architecture in the field’, Plant Soil 341: 75-87; Zhu, J., Ingram, P. A., Benfey, P. N. and Elich, T. (2011) ‘From lab to field, new approaches to phenotyping root system architecture’, Current opinion in plant biology 14(3): 310-7). First, soil is optically dense, limiting ability to visualize root growth and development at high spatial and temporal resolution. As a consequence, most studies aimed at understanding the mechanisms controlling root growth utilize highly synthetic media such as solidified agar. Second, soil is a multi-phase matrix of organic and inorganic materials, polymers, gas-filled voids and inhomogenous distributions of water and nutrients (Brady, N. C. and Weil, R. R. (2008) The Nature and Properties of Soils, Upper Saddle River, N.J.: Pearson-Prentice Hall.). Such heterogeneity is difficult to recapitulate in the lab and very little is known concerning how the various properties of these materials influence the root. Finally, soils vary dramatically among geographic locations. Soils excavated from a field location will differ significantly from a sample taken a few kilometers or even a few meters away. As such, the ability to standardize growth conditions and compare results can be difficult. Thus, it is necessary to develop new methods and approaches, which utilize novel soil-like conditions to understand the role of soil-properties in guiding root growth (Herder, G. D., Van Isterdael, G., Beeckman, T. and De Smet, I. (2010) ‘The roots of a new green revolution’, Trends in plant science 15(11): 600-7).

### SUMMARY OF THE INVENTION

The present invention provides for methods for determining how stressors affect plant root growth by providing a root cell of a plant modified with a first nucleic acid that encodes a first luminescent protein gene and a second nucleic acid that encodes a second luminescent or fluorescent protein, wherein the first nucleic acid is controlled by a constitutive promoter and the second nucleic acid is controlled by an inducible promoter. An initial determination of luminescence (and/or fluorescence) of the reporter proteins may or may not be made, followed by contacting the root cell with a stressor. Luminescence/fluorescence may then be determined or re-determined and changes in luminescence/fluorescence observed. The stressor may change the intensity of luminescence/fluorescence of the second luminescent/fluorescent protein in response to the stressor. The change in intensity reflects an effect of the stressor on the inducible promoter, thereby indicating that the stressor affects expression of a gene regulated by the inducible promoter. The inducible promoter may be derived from a gene known to respond to the stressor or from a gene not known to respond to the stressor.

The present invention also provides root cells of a plant comprising a first nucleic acid that encodes a first luminescent protein gene and a second nucleic acid that encodes a second luminescent or fluorescent protein, wherein the first nucleic acid is controlled by a constitutive promoter and the second nucleic acid is controlled by a promoter of a gene of interest.

The present invention further provides systems for determining how a stressor affects genes of a root cell by providing the root cell with a vessel and soil coupled with a means for detecting or measuring luminescence emitted by the root cell. The vessel comprises at least two planar transparent surfaces separated by spacers that provide a container for surrounding a root cell completely with soil. The vessel is closed with an opening at the other to allow for growth of a plant stem. The vessel may be sealed or may provide small openings to permit the flow of water and/or stressors to the soil. The planar surfaces of the vessel may permit detection and/or measurement of luminescence through the soil by the planar surfaces.

The present invention provides methods of visualizing plant root structure in non-transparent or non-translucent soil by providing a root cell of a plant that expresses a first luminescent protein gene operably linked to a promoter. The luminescence of the first luminescent protein is detected, and an image of the plant root structure in the non-transparent or non-translucent soil is generated based upon the detected luminescence of the first luminescent protein.

### BRIEF DESCRIPTION OF THE DRAWINGS

FIG. 1 shows the GLO-Roots system. FIG. 1A shows a rhizotron composed of two polycarbonate sheets separated by 2 mm thick spacers and filled with Pro-MIX soil. Light and dark arrow heads mark seedlings with and without PRR5::LUC2 reporters, respectively. Plants grown for 16 days. Luminescence measure using IVIS 100 system with a 5 minute exposure. Image is a composite of the Brightfield and luminescence images. FIG. 1B shows that GLO-Roots system can detect root structures not visible using brightfield imaging. FIG. 1C shows rhiztrons imaged on both sides and luminescence images, false covered and merged. Roots traverse across the soil and certain regions are more visible on one side than the other. FIG. 1D shows the same plant as in 1A to 1C after 25 dpg. False colored root systems at 16 dpg and 25 dpg overlaid to illustrate time-dependent changes in RSA. FIG. 1E shows semi-automated segmentation of the root structure using the Simple Nuerite Tracer plugin for ImagaJ. FIG. 1F shows quantitation of root lengths for root system reveal the presence of 3 classes of roots.

FIG. 2 shows visualization of peak auxin response and lateral root primordia. FIG. 2A shows a Brightfield and Luminescence of the DR5::LUC+ auxin reporter in the Rhizotron. FIG. 2B shows a composite image of luminescence signal obtained by imaging both sides of the rhizotron. The presence of punctate reporter expression marking presumptive lateral root primordia is visible (depicted by arrows).

FIG. 3 depicts one exemplary configuration of the vessels of the present invention

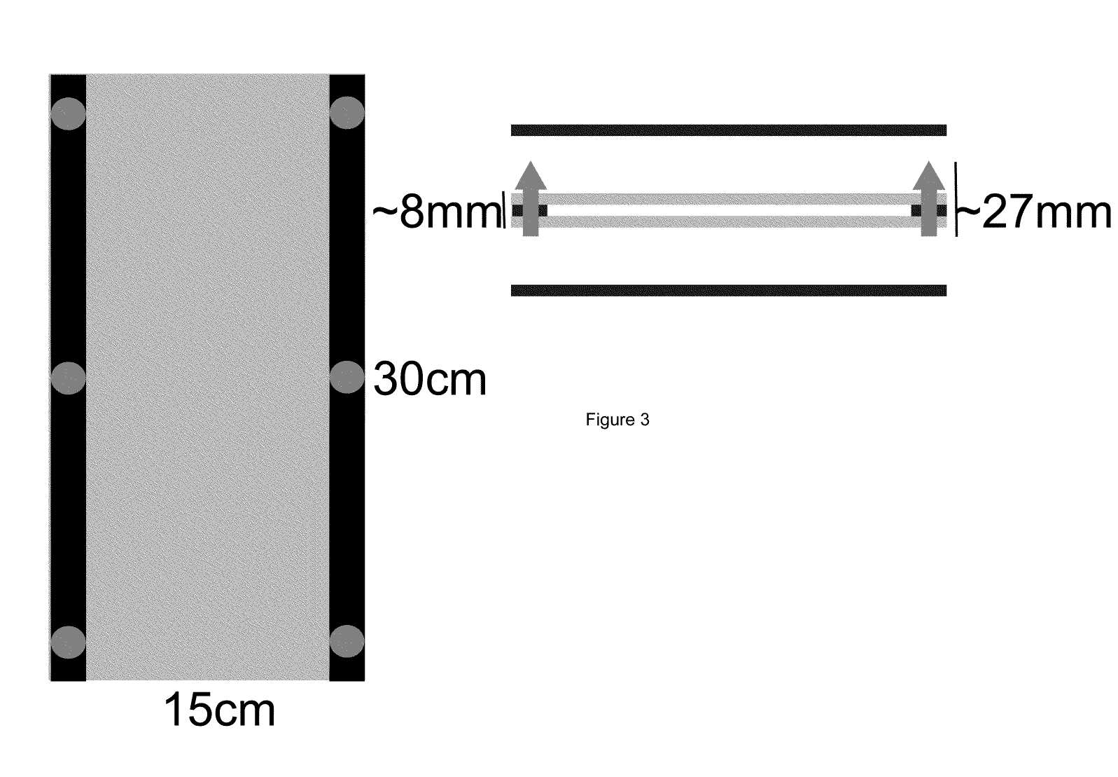

FIG. 4 depicts one example of the systems of the present invention

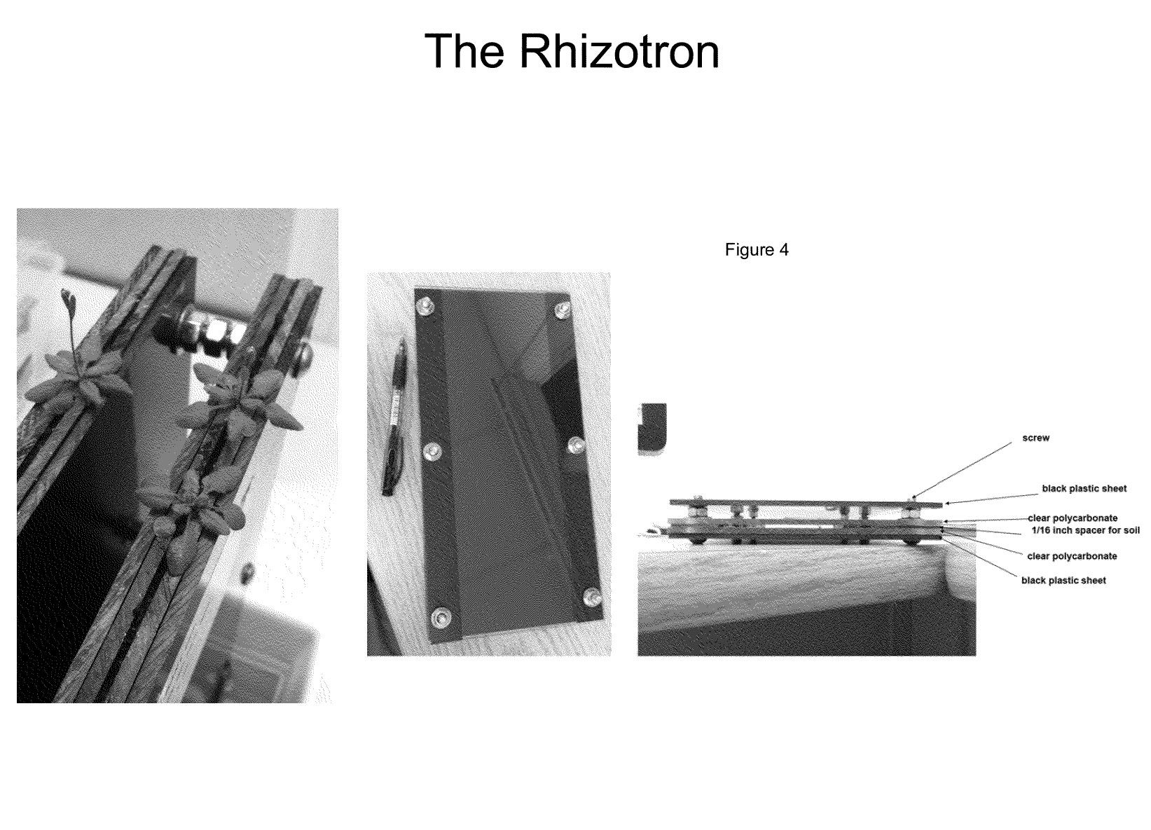

FIG. 5 depicts results obtainable from the systems and methods of the present invention.

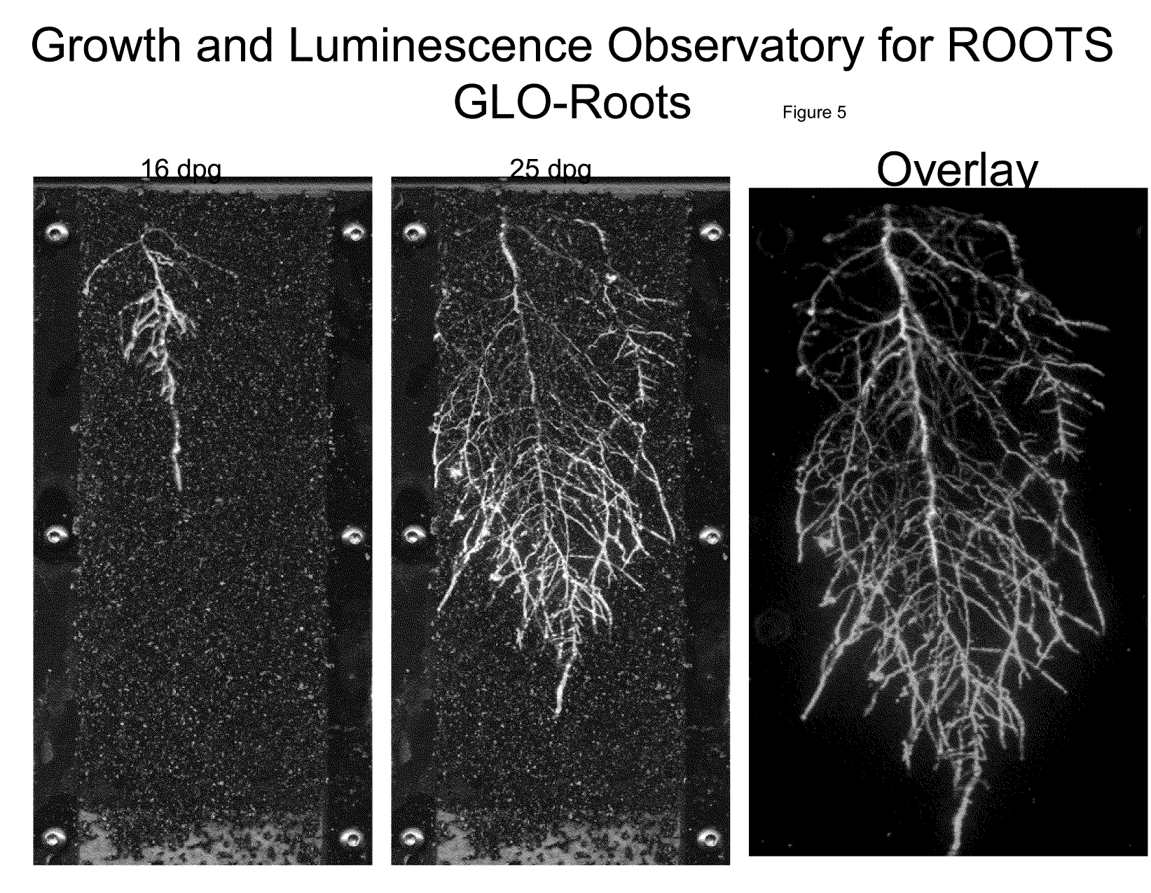

FIG. 6 depicts results obtainable from the systems and methods of the present invention.

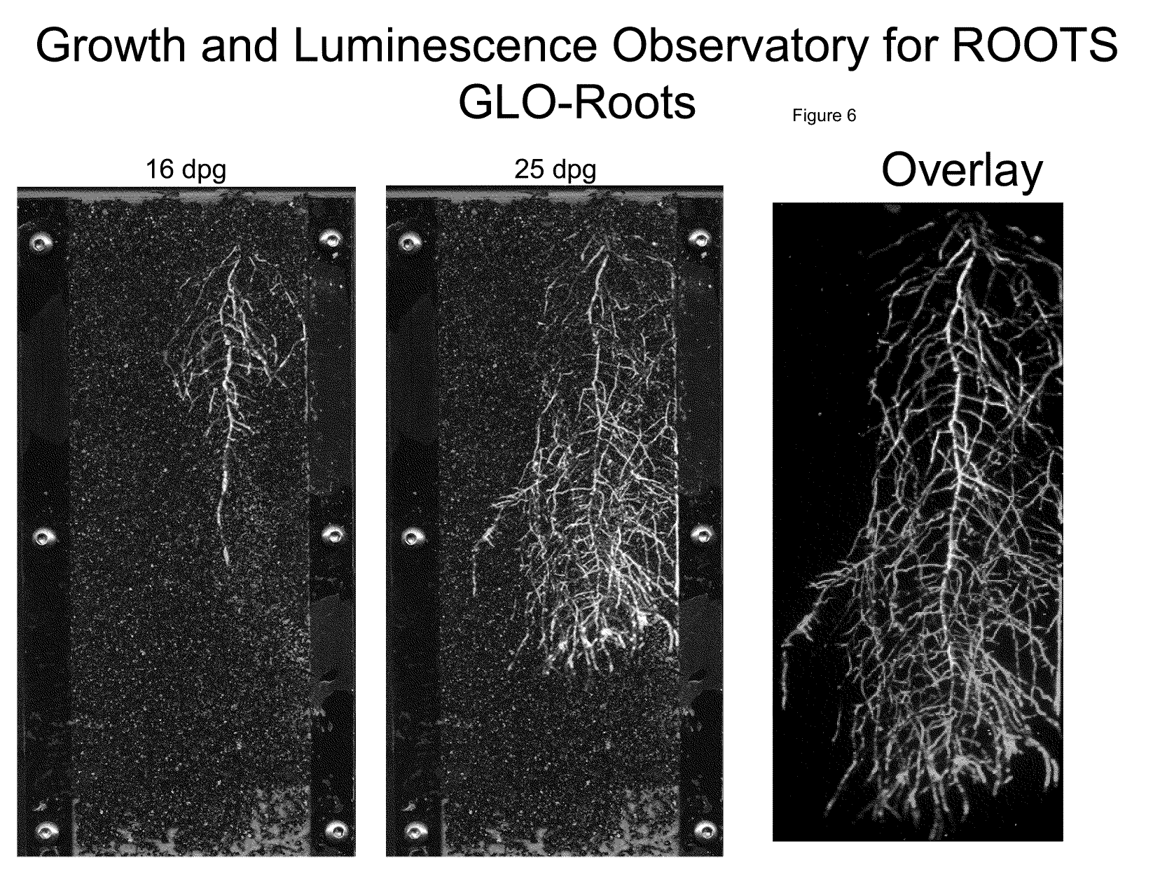

FIG. 7 depicts results obtainable from the systems and methods of the present invention. In particular, the methods and systems of the present invention were used to elucidate plagiotropic roots of Arabidopsis thaliana just below the surface of the soil.

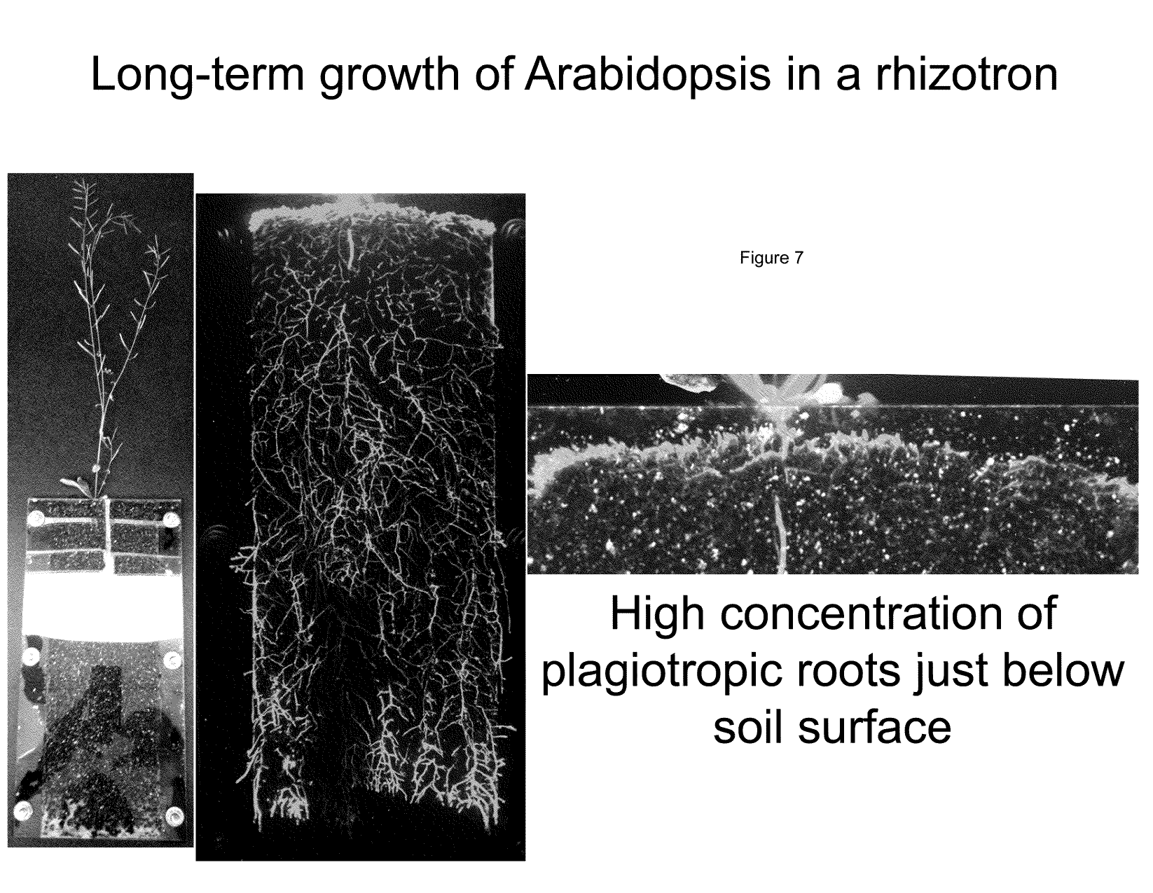

FIG. 8 depicts results obtainable from the systems and methods of the present invention.

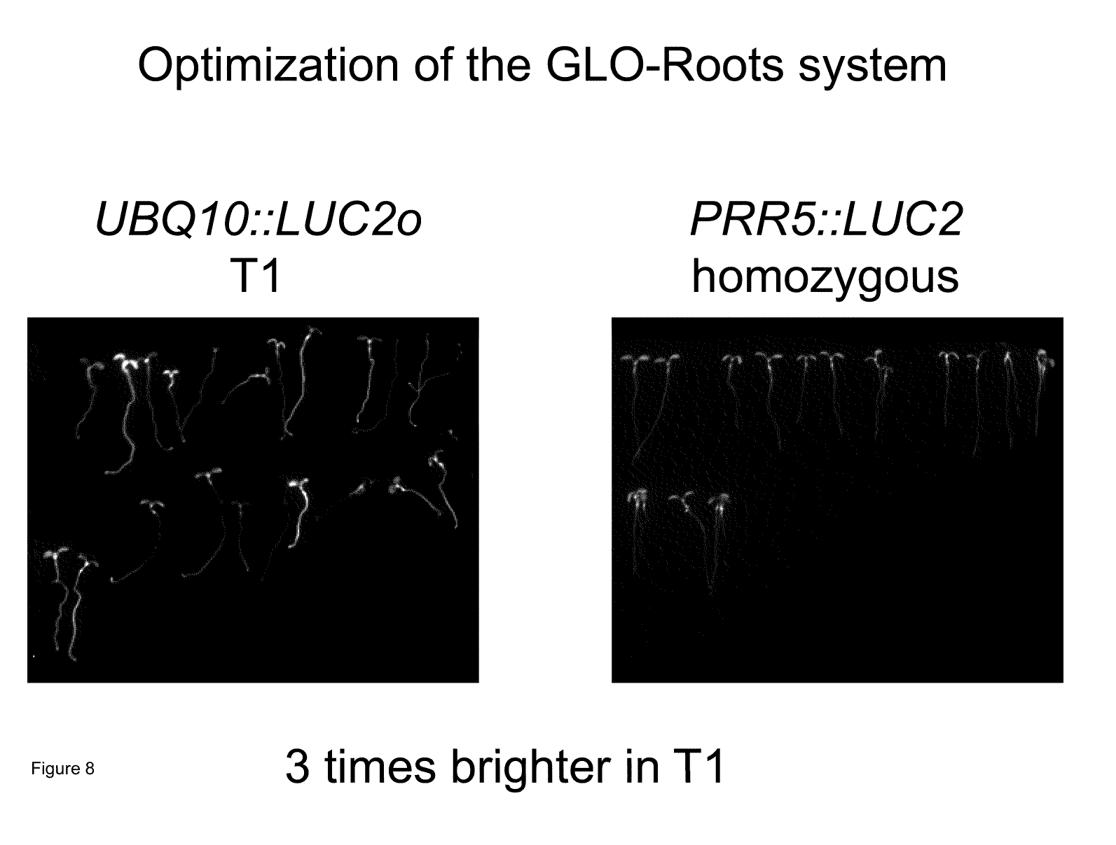

FIG. 9 depicts results obtainable from the systems and methods of the present invention.

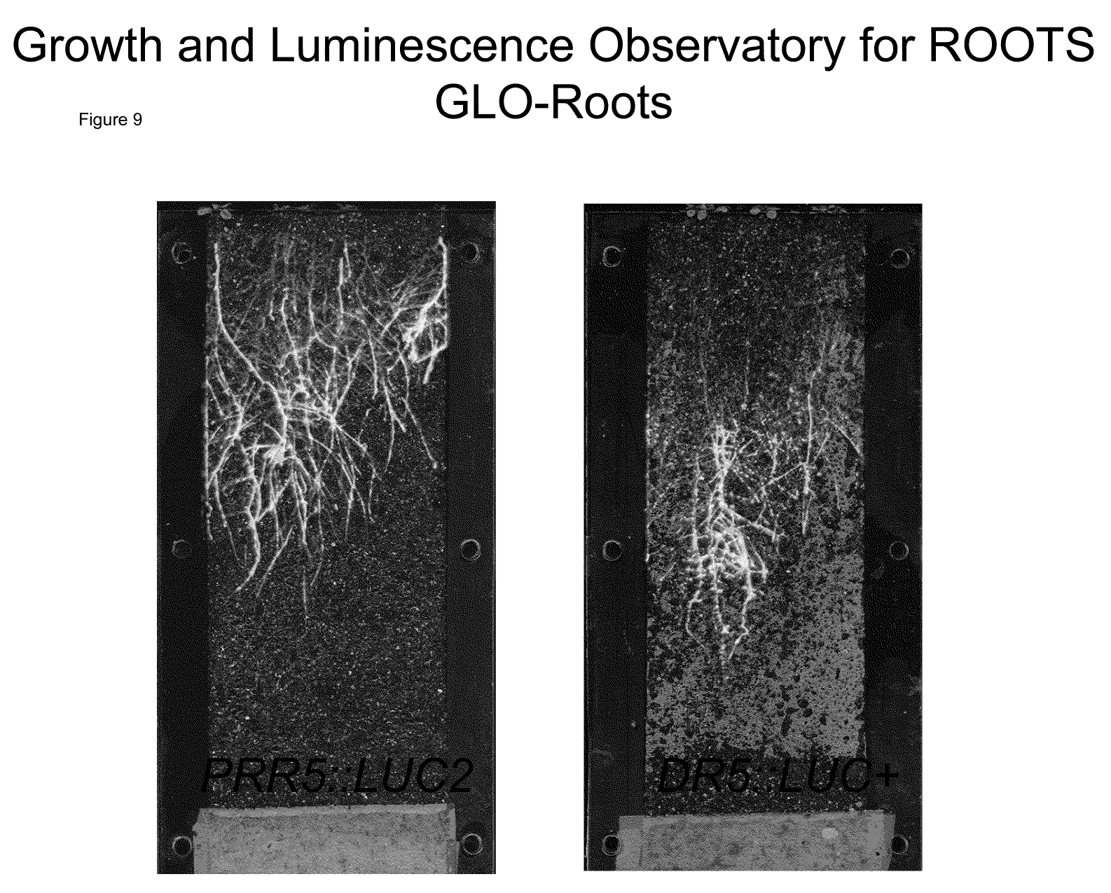

FIG. 10 depicts a few of the applications for which the methods and systems of the present invention can be useful.

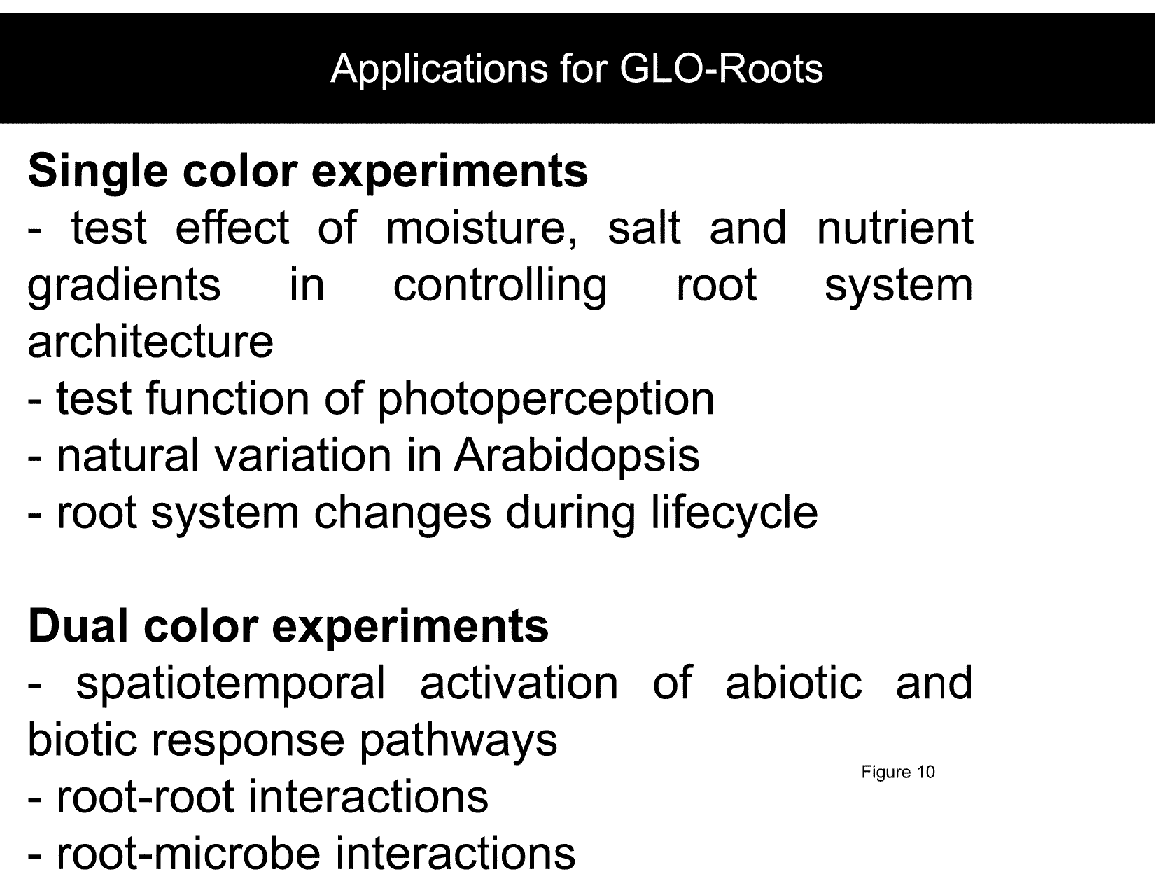

FIG. 11 depicts results obtainable from the systems and methods of the present invention.

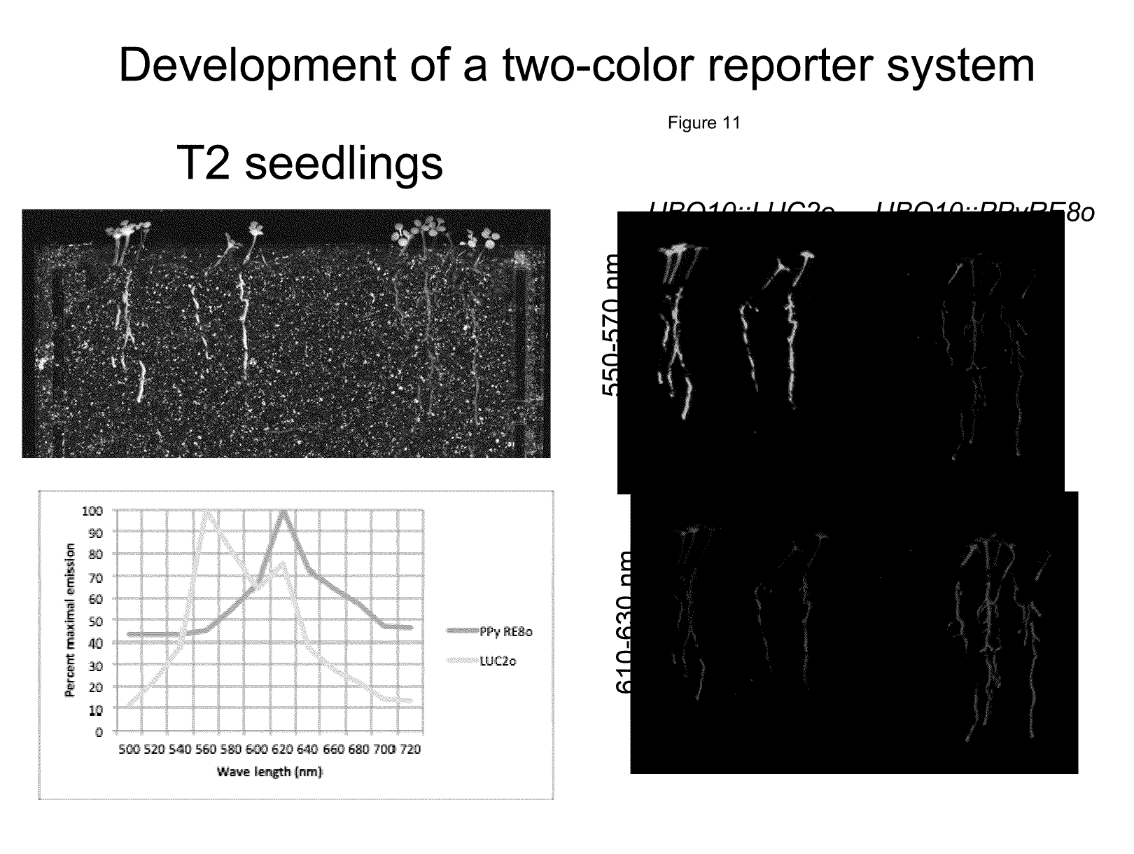

FIG. 12 depicts results obtainable from the systems and methods of the present invention.

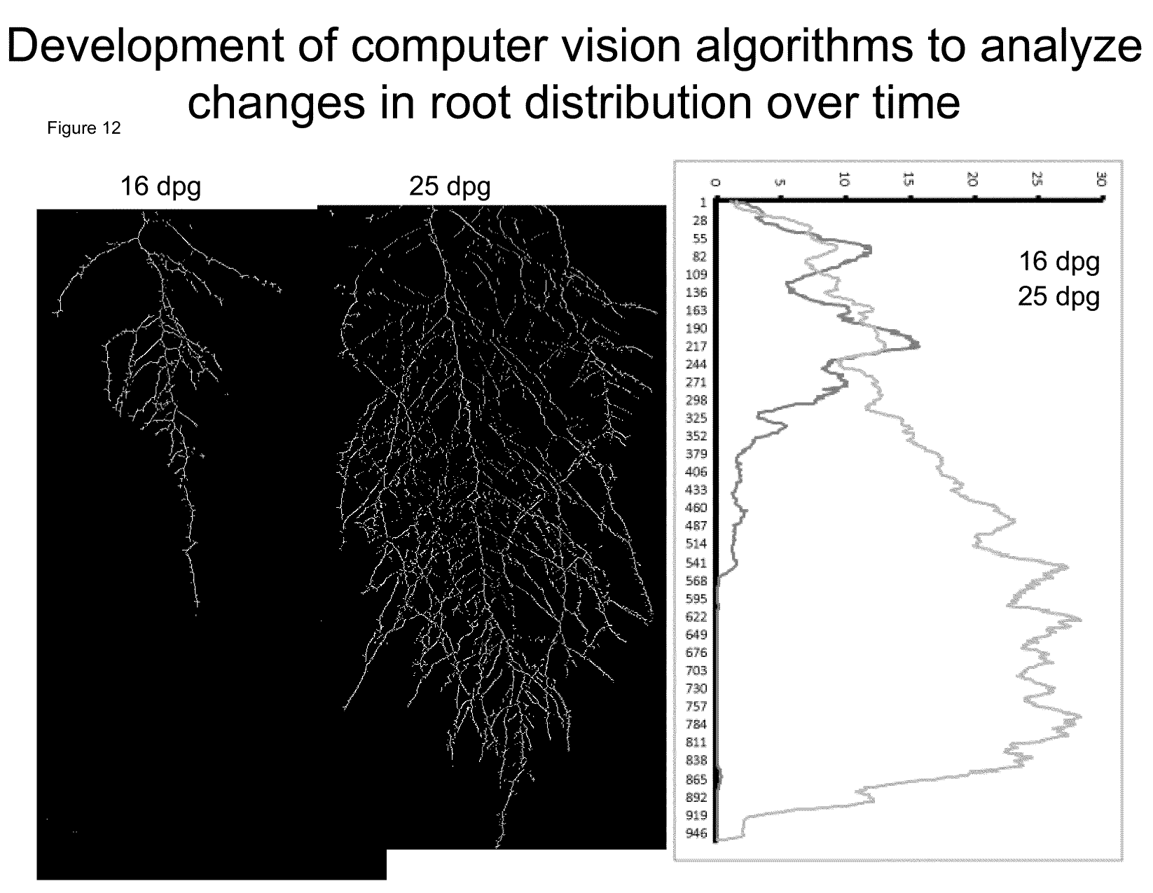

FIG. 13 depicts the expression of luciferases in plants that emit different wavelengths of light. A. A Chart of different luciferases, their origin and emission wavelengths. B. Different isoforms of luciferase were expressed in Arabidopsis thaliana. Visualization of luminescence reveals that these proteins can be expressed in plants and emit luminescence at different wavelengths of light.

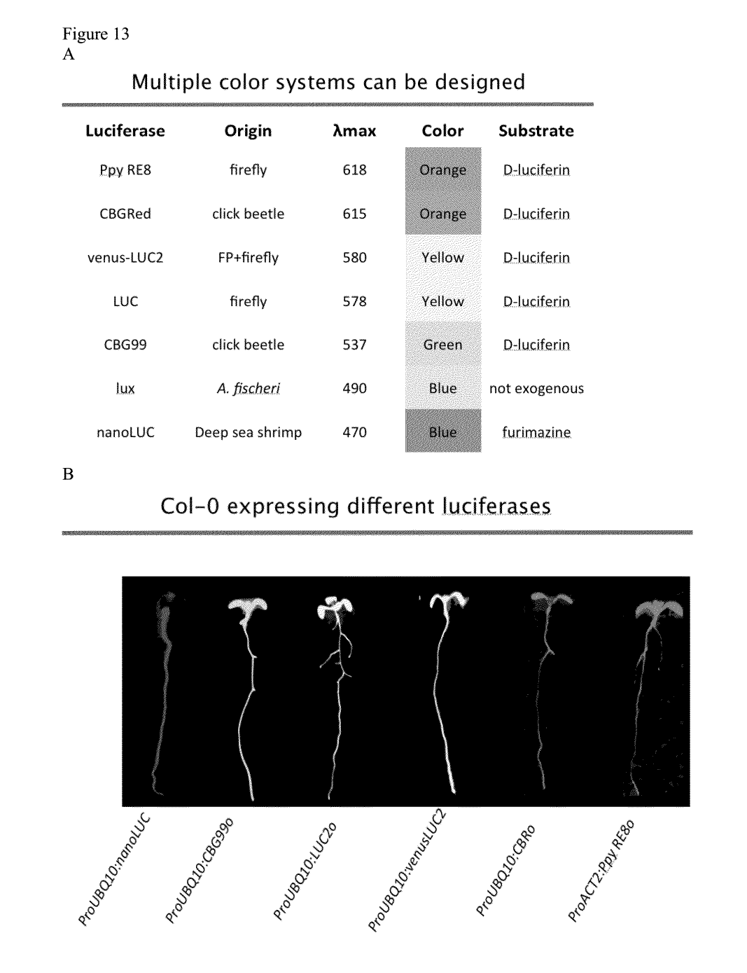

FIG. 14 depicts using luminescence to visualize root-microbe interactions. The LUX operon was introduced into a Pseudomonas fluorescence bacterial strain to visualize the localization via luminescence. Plants expressing the ProUBQ10:LUC2o reporter were grown in rhizotrons and inoculated with a water-bacterial solution. The bacteria colonization was observed and co-localized with the roots.

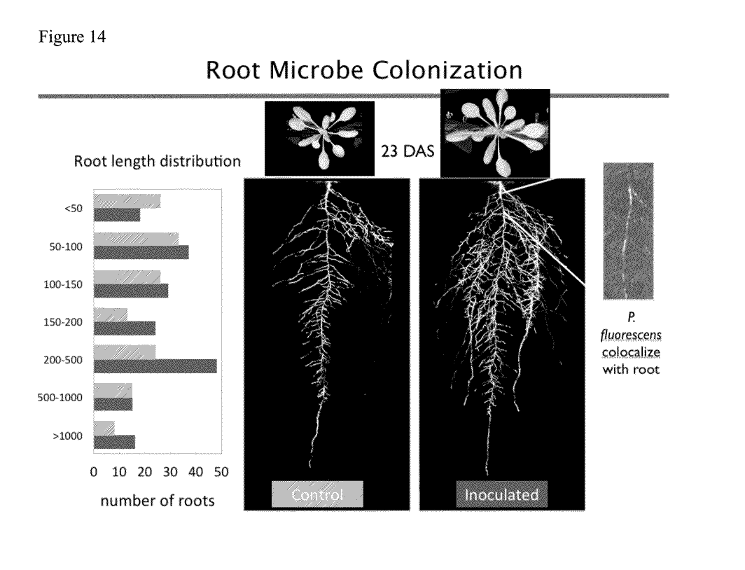

### DETAILED DESCRIPTION OF THE INVENTION

The present invention provides for a method for determining how stressors affect plant root growth by providing a root cell with isolated genes encoding two different reporter proteins. The first reporter is a luminescent protein gene is encoded by a nucleic acid operably linked to a constitutive or inducible promoter and the second luminescent or fluorescent protein is encoded by a nucleic acid that is operably linked to a constitutive or inducible promoter or a promoter derived from a gene of interest. The root cell is then contacted with the stressor and changes in luminescence/fluorescence are determined. A change in luminescence/fluorescence of the second luminescent/fluorescent protein indicates that the stressor affects the expression of the gene of interest. The present invention provides for performing this method in a vessel that surrounds the root cell with soil.

The present invention provides in part for a system that permits a root growth and imaging platform (Growth and Luminescence Observatory for Roots, GLO-Roots) to quantify root system dynamics in soil. The present invention provides in part a method and a system for molecular phenotyping of the root system in soil. Further, the present invention provides in part for the use of different soil types and simulated soils with controlled physical characteristics to understand the relationship between soil matrix properties and root growth. The invention opens a new standard in model plant growth systems and establishes the first high-resolution anatomical and molecular view of root biology in the natural context of soil.

The present invention provides for a root cell expressing at least two reporter proteins. In one embodiment, at least one of the reporter proteins is a luminescent protein. In another embodiment, at least two of the reporters are luminescent proteins. One of skill in the art will readily understand the class of proteins that are luminescent proteins. The first and the second luminescent proteins should differ from each other, such that expression of the first luminescent protein that is driven by the first promoter can be differentiated from expression of the second luminescent protein controlled by the second promoter. The luminescent proteins may be different in that they are different proteins entirely, or that they are modified versions in that they are modified to emit light at different wavelengths. The term “luminescent protein” refers to an expressed polypeptide that emits light as a result of an enzymatic reaction. The term “luminescence,” as used herein does not include fluorescence. As used herein, fluorescence from a fluorescent protein or other compound requires excitation of the protein or compound with light, and the protein of compound, in turn, emits light at a different wavelength. In one embodiment, all reporter proteins used in the methods and systems of the present invention are luminescent proteins and do not require the input of light energy to generate emitted light. Examples of luminescent proteins include but are not limited to firefly luciferase, renilla luciferase, deep-water shrimp luciferase, e.g., Acanthephyra purpurea and bacterial luciferase. These and other luminescent proteins are readily available and are commonly known throughout the art. Variants of the luminescent proteins above and other known luminescent proteins may also be used within the scope of the methods and systems of the present invention and the invention is not limited by the specific identity (amino acid sequence) of the luminescent proteins used, provided that the two proteins used in the system are sufficiently different from one another as described herein.

The luminescent protein may or may not be fused or linked to a fluorescent protein. In another embodiment of the methods and system of the present invention, at least one of the reporter proteins is a fluourescent protein and at least one of the reporter proteins is a luminescent protein. In these embodiments, the detecting and visualization of the reporter proteins can utilize a bioluminsescent resonance energy transfer (BRET) reaction between the luminescent protein and the fluorsescent protein. Examples of fluorescent proteins include, but are not limited to, green fluorescent proteins (GFP, AcGFP, ZsGreen), red-shifted GFP (rs-GFP), red fluorescent proteins (RFP, including DsRed2, HcRed1, dsRed-Express), yellow fluorescent proteins (YFP, Zsyellow), cyan fluorescent proteins (CFP, AmCyan), a blue fluorescent protein (BFP), citrine, cerulean, VENUS, teal fluorescent protein (TFP), and the phycobiliproteins, as well as the enhanced versions and mutations of these proteins. Fluorescent proteins as well as enhanced versions thereof are well known in the art and are commercially available. For some fluorescent proteins, “enhancement” indicates optimization of emission by increasing the protein's brightness or by creating proteins that have faster chromophore maturation. These enhancements can be achieved through engineering mutations into the fluorescent proteins.

The nucleic acids encoding the first and second reporter proteins are operably linked to the first and second promoters, respectively. One of skill in the art will comprehend what operably linked entails and will understand how to make nucleic acids that are operably linked to one another. Briefly, sequences are said to be operably linked or joined when they are covalently linked to one another in such a way as to place the expression or transcription of one nucleic acid under the influence or control of the other nucleic acid promoter sequences. The operably linked promoter and nucleic acid encoding the luminescent protein may be in a vector or a plasmid. Those of skill in the art will appreciate the structure of a vector and a plasmid and will appreciate the features that may be included, such as but not limited to cloning sites, resistance elements and points of origin.

The methods of the present invention entail having promoters operably linked to a nucleic acid encoding a luminescent and/or fluorescent protein. As known to one of skill in the art, a promoter is an array of nucleic acid control sequences that direct transcription of a nucleic acid. A promoter often includes nucleic acid sequences near the start site of transcription, such as but not limited to, a TATA element or a CAT element. A promoter may also include distal enhancer or repressor elements, which can be located as much as several thousand base pairs from the start site of transcription.

A constitutive promoter refers to a promoter that is active under most environmental and developmental conditions, i.e., the promoter is almost always “on.” Many different constitutive promoters can be utilized in the instant invention. For example, in a plant cell, constitutive promoters include, but are not limited to, the promoters from plant viruses such as the 35S promoter from CaMV (Odell et al., Nature 313: 810-812, 1985) and the promoters from such genes as rice actin (McElroy et al., Plant Cell 2: 163-171, 1990); ubiquitin (Christensen et al., Plant Mol. Biol. 12:619-632, 1989, and Christensen et al., Plant Mol. Biol. 18: 675-689, 1992); pEMU (Last et al., Theor. Appl. Genet. 81:581-588, 1991); MAS (Velten et al., EMBO J. 3:2723-2730, 1984) and maize H3 histone (Lepetit et al., Mol. Gen. Genetics 231: 276-285, 1992 and Atanassova et al., Plant Journal 2(3): 291-300, 1992). The constitutive promoters used herein can be wild-type or mutants thereof. Constitutive promoters are well known in the art.

An inducible promoter refers to a promoter whose activity is induced in response the presence or absence of an inducer. An inducer can be, but is not limited to, a biological, chemical or physical factor, such as but not limited to, proteins, antibiotics, ions, heat, cold, etc. One of skill in the art readily understands the term inducible promoter. The inducible promoter may be a wild-type promoter or a mutant thereof. The inducible promoter may or may not be derived from a gene known to be regulated by the stressor or from a gene of interest suspected to be affected by the stressor. By being inducible, transcription and/or expression of the luminescent protein may be upregulated or downregulated in response to contact with the stressor. Upregulation or downregulation of expression of the luminescent protein is indicative that the stressor affects expression of the gene from which the inducible promoter is derived.

The inducible promoter may be the promoter that is normally associated with a gene that is important for root cell function, such as communicating with other plant organs, distributing nutrients and water, and reacting and interacting with its environment, such as the soil and the contents thereof. By way of example, and not as a limitation, the inducible promoter may include RD29Ap (which activates expression in the root in response to abiotic stress including drought and salt stress and responsive to abscisic acid); RAB18p (which induces expression in the root in response to abiotic stress including drought and salt stress and is responsive to abscisic acid); DR5p (which induces expression in response to the hormone auxin and marks early stage lateral roots and root tips); UBQ10p and 35Sp (constitutive expression in the root); 4xNREp (which induces expression in the root in response to low nitrate levels in the environment); CYP71A12p (which induces expression in the root in response to pathogen elicitors); AtALMT1p (which induces expression in response to low pH and Aluminum toxicity); AtIPS1p (which induces expression in the root in response to low phosphate in the environment); NRT2.1p (which induces expression in the root in response to low nitrate); AT1G73010p (which induces expression in the root in response to low phosphate); PR-1p (which induces expression in the root in response to pathogen attack); ADH-1p (which induces expression in the root in response to hypoxia); and TCH4p (which induces expression in the root in response to touch, heat, cold, darkness and Brassinosteroid hormone).

Those skilled in the art will appreciate that the promoters of the present invention provide for systems that allow for determination and diagnosis of gene activity in a cell. For example, the use of RD29Ap provides a diagnostic reporter for water stress responses at the spatiotemporal level in the root system; the use of RAB18p provides a diagnostic reporter for water stress responses at the spatiotemporal level in the root system; the use of DR5p provides a diagnostic reporter for auxin physiology and root development; the use of 4xNXREp provides a diagnostic reporter for low nitrate responses at the spatiotemporal level in the root system; the use of CYP71A12p provides a diagnostic reporter for phosphate starvation responses at the spatiotemporal level in the root system; the use of AtALMT1p provides a diagnostic reporter for soil acidity and aluminum toxicity at the spatiotemporal level in the root system; the use of AtIPS1p provides a diagnostic reporter for phosphate starvation at the spatiotemporal level in the root system; the use of pNRT2.1 provides a diagnostic reporter for nitrate starvation at the spatiotemporal level in the root system; the use of pAT1G73010 provides a diagnostic reporter for phosphate starvation at the spatiotemporal level in the root system; the use of PR-1p provides a diagnostic reporter for pathogen attack at the spatiotemporal level in the root system; the use of ADH-1p provides a diagnostic reporter for hypoxia at the spatiotemporal level in the root system; and the use of TCH4p provides a diagnostic reporter for touch, heat, cold, darkness and Brassinosteroid at the spatiotemporal level in the root system. Accordingly, one of skill will be able to choose an appropriate promoter for the systems and methods described herein based upon the stressor studied.

Through the coupling of a promoter of a gene of interest to a nucleic acid encoding a luminescent or fluorescent protein, factors that would otherwise affect expression of the gene of interest, will affect the expression of the luminescent or fluorescent protein. Changes in luminescence/fluorescence emitted from a root cell may be indicative of upregulation/downregulation in response to a change in the environment of the soil.

The nucleic acids comprising the promoters operably linked to the nucleic acids encoding the luminescent/fluorescent proteins can be introduced into a root cell. The term “root cell” as used herein means a cell or group of cells that are from or part of the root of a plant. A “root” is typically considered the portion of the plant that typically, but not always, lies below the surface of the soil and bears no leaves, flowers or nodes. In one embodiment, the present invention provides for a root cell containing the nucleic acids described herein. The root cell may be derived from any plant, for example, and not by way of limitation, the root cell may be derived from Arabidopsis, Brassica, Glycine, Oryza, Zea, Triticum, Setari or Hordeum. The root cell may be part of a root, which may be part of a whole plant or explant thereof.

Those of skill in the art will appreciate that the nucleic acids may be placed in an expression vector to assist in delivering the nucleic acids to a root cell and to assist in expression of the luminescent/fluorescent protein. In plants, vectors capable of introducing DNAs are easily designed, and generally contain one or more DNA coding sequences of interest under the transcriptional control of 5′ and 3′ regulatory sequences. Plant vectors also generally contain a selectable marker. Typical 5′-3′ regulatory sequences include a transcription initiation start site, a ribosome binding site, an RNA processing signal, a transcription termination site, and/or a polyadenylation signal. Plant vectors have been reviewed in Rodriguez et al. (1988) Vectors: A Survey of Molecular Cloning Vectors and Their Uses, Butterworths, Boston; Glick et al. (1993) Methods in Plant Molecular Biology and Biotechnology CRC Press, Boca Raton, Fla.; and Croy (1993) In Plant Molecular Biology Labfax, Hames and Rickwood, Eds., BIOS Scientific Publishers Limited, Oxford, UK, all of which are incorporated by reference herein in their entirety. Non-limiting examples of plant vectors useful in the present invention include but are not limited to pMON30423, pMON29141, pMON43007, pCGN5139, and pMON43011. Those of skill in the art will appreciate that the nucleic acids, including but not limited to vectors, may be introduced into the root cell by techniques known in the art, such as transformation, transient transfection, stable transfection, microinjection or by genetically engineering the root cell, such as by bombardment, agrobacterium-mediated transfection, agrobacterium-mediated stable transformation and other techniques known in the art.

The present invention provides for contacting the root cell with a stressor. A stressor refers to an environmental condition, a chemical or biological compound, the presence or absence of which may affect the profile of genes expressed. The stressor may or may not act directly with the inducible promoter, or the stressor may trigger a cellular signaling mechanism that regulates the inducible promoter. The stressor may trigger activation of the inducible promoter or it may cause repression of the inducible promoter. Those skilled in the art will appreciate that as the stressor affects the inducible promoter, expression of the operably coupled nucleic acid encoding the luminescent protein is affected too.

The stressor may be exposure or deprivation of an environmental condition, such as water or nutrients. The stressor may be an injury, to the root cell, the root or another organ within a plant. The stressor may be an attack on the root cell, the root or other organ of the plant. The stressor may be a pathogen attack, such as a bacteria, fungus or virus. The stressor may be contact with a beneficial nutrient or organism, such as rhizobium or Arbuscular mycorrhiza fungi.

The stressor also includes environmental changes such as but not limited to a change in salinity, soil compaction, temperature, available water, acidity, alkalinity, and available nutrients, such as available amino acids, sugars, nitrogen, carbon, oxygen, phosphorous, potassium, sodium, sulfur and zinc.

The methods of the present invention utilize detection and measuring of luminescence and/or fluorescence. Methods and means for detecting and/or measuring luminescence/fluorescence are known in the art, such as through instrumentation that is sensitive to light emission. Luminescence/fluorescence may be detected and/or measured at particular points in time or continuously over a course of time. Detection and/or changes to luminescence/fluorescence may be recorded to an instrument for documentation. Changes in luminescence/fluorescence may be absolute or incremental. A change in luminescence/fluorescence may be a ratio or percentage as compared to an earlier obtained value. Detecting luminescence/fluorescence in the root cell may be performed at one or more point around the three-dimensional structure of the root cell, for example at two or more points around the circumference of the root cell. Repeated detection may occur at the same points or approximate to the same points on the root cell at the same or similar distance in order to provide an accurate comparison.

The present invention provides for a planting vessel to contain the root cell. The root cell may be in a planting vessel surrounded by soil. As used herein, the term soil is used to mean any matrix that that can support plant growth. The soil need not be capable of supporting all plant species or types of plant life. The soil may or may not contain nutrients including, but not limited to water, mineral, etc. Soil may constitute a synthetic mixture of clay, silt, sand and organic material and other substances, and it may also constitute a naturally occurring mixture of these substances or a mixture of natural and synthetic soils. In one embodiment, the soil used in the methods and systems of the present invention is transparent or translucent. A synthetic gel-type matrix would be considered a transparent or translucent soil for the purposes of the present invention. In one embodiment of the present invention, the soil used in the methods and systems of the present invention is not transparent or translucent such that the soil scatters incident light. Dirt, sand, potting soil, peat moss and other natural soils would be considered soil that was not transparent for the purposes of the present invention.

The planting vessel allows for a plant to be cultivated and permits the soil to cover and completely surround the root cell with the soil being at a thickness of between 0.1 mm to 3 mm around the root tissue. Thus the planting vessels described herein are open on one side to allow the non-root portions of the cultivated plant to grow as they normally would, i.e., generally towards a light source. The remaining sides or dimensions of the planting vessel described herein are substantially closed or sealed. By “substantially closed” it is intended that the non-open portions of the vessel are either completely water-tight and/or air-tight or that the sides or dimensions allow for minimal water or air passage. For example, one of the surfaces of the planting vessel described herein may be substantially air tight except that the surface may contains holes or passages for venting, watering or feeding purposes. In one embodiment, the planting vessel is water-tight such that water can enter or exit the vessel through only the open side or dimension of the vessel. In another embodiment, the planting vessel is substantially water-tight such that the vast majority of water can enter or exit the vessel through only the open side or dimension of the vessel, but that the vessel allows or permits the exiting or entrance of smaller portions of water through the closed sides or dimensions of the planting vessel.

The vessel of the present invention provides for at least two planar surfaces that are separated by spacers. In one embodiment, the planar surfaces are parallel to one another. In another embodiment, the planar surfaces are not parallel to one another. In one embodiment, the planar surfaces are transparent that allow for passage of any wavelength or frequency of light. In another embodiment, the planar surfaces are opaque. In another embodiment, the planar surfaces are transparent surfaces that allow for passage for select frequencies or wavelengths of light, such as but not limited to, surfaces with red, green, blue, yellow light filters. In yet another embodiment, the planar surfaces are polarized to allow passage of light only at certain orientations. The width of the spacers separating the at least two planar surfaces permits a root cell, or a root system to be placed in the vessel and covered entirely in soil and allows for growth or cultivation of the entire plant. Those skilled in the art will appreciate that such an arrangement requires for an exit point from the soil for the rest of the plant, should the rest of the plant be desired for the studies at hand. The vessel may be entirely transparent, including the spacers.

In one simple embodiment of the present invention, the planting vessel has 6 sides, with 5 sides being closed or substantially closed and one side being open enough to allow the non-root portion of a plant to grow, in general, toward a light source. Opposite the open side is a closed or substantially closed side that may or may not be parallel to the open side. Of the remaining 4 sides in this embodiment, two of the sides are closed or substantially closed and are planar and large enough to allow for visualization of the root structure using the methods described herein. The width of the two, large planar surfaces may be at least about 2 cm, 4 cm, 6, cm, 8, cm, 10 cm, 12 cm, 14 cm, 16 cm, 18 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm 95 cm or 100 cm or even more. The height of the two large planar surfaces should be high enough to allow for root development and growth in the soil and, in general, away from the top of the open surface. The height of the two large planar surfaces, as measured from the top of the open surface of the vessel can be at least about 2 cm, 4 cm, 6, cm, 8, cm, 10 cm, 12 cm, 14 cm, 16 cm, 18 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm 95 cm or 100 cm or even more. The two, large planar surfaces may or may not be parallel to one another.

The two remaining sides in this embodiment are closed or substantially closed and are narrow, with the width of each of these narrow sides being generally defined by the spacers described herein. The vessel is configured such that the width of each of the two narrow sides is 5 mm or less. In more specific embodiments, the width of each of the two narrow sides is 4 mm or less, 3 mm or less, 2mm or less and 1 mm or less. The height of the two smaller, narrow surfaces may or may not be the same as the height of the two large planar surfaces. In general, the height of the two narrow smaller surfaces will be the same or roughly the same as the height of the two large, planar surfaces. The height of the two smaller, narrow surfaces, as measured from the top of the open surface of the vessel can be at least about 2 cm, 4 cm, 6, cm, 8, cm, 10 cm, 12 cm, 14 cm, 16 cm, 18 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm 95 cm or 100 cm or even more. The two, smaller narrow surfaces may or may not be parallel to one another.

Of course other vessels of more or less than six sides can be envisioned, provided the vessel has at least two large planar surfaces. In one embodiment, the planting vessel of the present invention does not allow for the root or root structure to grow or propagate along an inner surface of the vessel such that the soil in the vessel does not completely surround the root or root structure. In another embodiment, the sides of the vessel are either parallel or perpendicular to the ground, or the sides of the vessel are either roughly parallel or roughly perpendicular to the ground. As used herein, roughly parallel and roughly perpendicular is used to account for imprecision in construction of the vessel or the ground under which the vessel sits. In one aspect of the present invention, the vessel is configured such that the root or root structure does not grow or propagate on the inner surface of any side of the vessel. The planting vessel may or may not be angled away from light or encased in a shroud to block light with the above ground portion of the plant exposed to light. In one embodiment, a light-blocking sheeting covers the roots to prevent light from entering.

The vessel of the present invention should provide sufficient height to permit development of an entire root system, for example for Arabidopsis a height of about 50 cm should be sufficient. The vessel of the present invention may also be self-contained, so that added nutrients do not seep away. The vessel of the present invention may be angled at any degree desired, but in most instances, will be perpendicular to growth of the stem and the rest of the plant.

Root cells are placed in a soil in the planting vessel provided herein to provide for a layer of soil that acts as a natural habitat for the root cell and deprives light but still provides nutrients and water. The root cells may be between 0.1 μm to 3 mm from the wall of the vessel. The vessel may be, in part, transparent or translucent glass or polymer. The vessel may be round or angular in shape, such as a triangle, quadrangle, pentagon, hexagon or so forth. The vessel containing the root may be between 0.2 μm to 5 mm across.

The width of the vessel permits the distance of the soil between the root cell and the edge of the vessel to remain sufficiently thin that detection of luminescence within the root cell from outside the vessel remains possible. Those skilled in the art will appreciate that failing to cover the root cell entirely with soil lessens the natural habitat of the root cell. Those skilled in the art will further appreciate that the covering of soil cannot be so thick as to prevent detecting of the luminescent proteins. Those skilled in the art will also appreciate that the presence of a constitutive promoter operably coupled to a nucleic acid encoding a luminescent protein provides for consistent expression of the luminescent protein and accordingly, a quick reference as to whether the soil covering is too thick.

The present invention provides for determining luminescence/fluorescence from the root cell from more than one point from the exterior of the vessel, such as on opposing or adjacent sides of the vessel, or at pre-determined angular intervals rotating around the root cell, such as increments of 10, 20, 30, 40, 45, 50, 60, 70, 80, 90, 120, 180, 270 degrees, clockwise or counterclockwise. The present invention further provides for collecting various data points, such as at different time points, following a change in experimental conditions, such as adding a stressor to the soil. The data may be cumulative, such as a time lapse image, or may be viewed individually or in groups to evaluate a change over a period of time.

The present invention is based in part on a novel system of determining factors that affect activation or repression of a gene that is connected to an inducible promoter. Those skilled in the art will also appreciate that the methods of the present invention may extend to identifying other proteins or factors involved in activation or deactivation of inducible promoters. For example, introducing a modified version of a protein or factor suspected to be involved in a change in luminescence will provide for determination of its involvement as compared to a root cell where that protein or factor of interest remains unaltered from the wild-type state. Those skilled in the art will appreciate that a modification, such as a mutation to a constitutively active or inactive variant, or a mutation to prohibit or make permanent the binding of a cofactor, such as another protein, transcription factor or ion, will allow for easy determination if a suspected protein or factor is in fact involved in regulating the inducible promoter in response to the stressor.

The present invention also provides, in part, a system for determining how a stressor affects gene expression in a root or root cell. By providing the vessel and root cells discussed herein, along with soil, a system is assembled that allows for those skilled in the art to introduce a stressor and determine if expression of certain genes of interest is affected. As described herein, using the promoter of the suspected gene as the inducible promoter allows for the system to provide the necessary information to confirm if the stressor regulates expression of the genes of interest.

The present invention may utilize variants of nucleic acids and proteins, for example variants of luminescent or fluorescent proteins and the nucleic acids encoding them to optimize the system provided herein. The variants may retain at least 75%, 80%, 85%, 86%, 87%, 88%, 89%, 90%, 91%, 92%, 93%, 94%, 95%, 96%, 97%, 98%, 99% or 100% identity with those known in the art, such as the promoters, the luminescent proteins and nucleic acids encoding luminescent or fluorescent proteins described herein. Identity refers to a measure of the identity of nucleotide sequences or amino acid sequences compared to a reference nucleotide or amino acid sequence. In general, the sequences are aligned so that the highest order match is obtained. “Identity” per se has an art-recognized meaning and can be calculated using published techniques. (See, e.g., Computational Molecular Biology, Lesk, A. M., ed., Oxford University Press, New York (1988); Biocomputing: Informatics And Genome Projects, Smith, D. W., ed., Academic Press, New York (1993); Computer Analysis of Sequence Data, Part I, Griffin, A. M., and Griffin, H. G., eds., Humana Press, New Jersey (1994); von Heinje, G., Sequence Analysis In Molecular Biology, Academic Press (1987); and Sequence Analysis Primer, Gribskov, M. and Devereux, J., eds., M Stockton Press, New York (1991)). While there are several methods to measure identity between two polynucleotide or polypeptide sequences, the term “identity” is well known to skilled artisans (Carillo, H. & Lipton, D., Siam J Applied Math 48:1073 (1988)). Methods commonly employed to determine identity or similarity between two sequences include, but are not limited to, those disclosed in Guide to Huge Computers, Martin J. Bishop, ed., Academic Press, San Diego (1994) and Carillo, H. & Lipton, D., Siam J Applied Math 48:1073 (1988). Computer programs may also contain methods and algorithms that calculate identity and similarity. Examples of computer program methods to determine identity and similarity between two sequences include, but are not limited to, GCG program package (Devereux, J., et al., Nucleic Acids Research 12(i):387 (1984)), BLASTP, ExPASy, BLASTN, FASTA (Atschul, S. F., et al., J Molec Biol 215:403 (1990)) and FASTDB. Examples of methods to determine identity and similarity are discussed in Michaels, G. and Garian, R., Current Protocols in Protein Science, Vol 1, John Wiley & Sons, Inc. (2000), which is incorporated by reference.

In one embodiment of the present invention, the algorithm used to determine identity between two or more polypeptides is BLASTP. In another embodiment of the present invention, the algorithm used to determine identity between two or more polypeptides is FASTDB, which is based upon the algorithm of Brutlag et al. (Comp. App. Biosci. 6:237-245 (1990), incorporated by reference). In a FASTDB sequence alignment, the query and reference sequences are amino sequences. The result of sequence alignment is in percent identity. In one embodiment, parameters that may be used in a FASTDB alignment of amino acid sequences to calculate percent identity include, but are not limited to: Matrix=PAM, k-tuple=2, Mismatch Penalty=1, Joining Penalty=20, Randomization Group Length=0, Cutoff Score=1, Gap Penalty=5, Gap Size Penalty 0.05, Window Size=500 or the length of the subject amino sequence, whichever is shorter.

If the reference sequence is shorter or longer than the query sequence because of N-terminus or C-terminus additions or deletions, but not because of internal additions or deletions, a manual correction can be made, because the FASTDB program does not account for N-terminus and C-terminus truncations or additions of the reference sequence when calculating percent identity. For query sequences truncated at the N- or C-termini, relative to the reference sequence, the percent identity is corrected by calculating the number of residues of the query sequence that are N-and C-terminus to the reference sequence that are not matched/aligned, as a percent of the total bases of the query sequence. The results of the FASTDB sequence alignment determine matching/alignment. The alignment percentage is then subtracted from the percent identity, calculated by the above FASTDB program using the specified parameters, to arrive at a final percent identity score. This corrected score can be used for the purposes of determining how alignments “correspond” to each other, as well as percentage identity. Residues of the reference sequence that extend past the N- or C-termini of the query sequence may be considered for the purposes of manually adjusting the percent identity score. That is, residues that are not matched/aligned with the N- or C-termini of the comparison sequence may be counted when manually adjusting the percent identity score or alignment numbering.

For example, a 90 amino acid residue query sequence is aligned with a 100 residue reference sequence to determine percent identity. The deletion occurs at the N-terminus of the query sequence and therefore, the FASTDB alignment does not show a match/alignment of the first 10 residues at the N-terminus. The 10 unpaired residues represent 10% of the reference sequence (number of residues at the N- and C-termini not matched/total number of residues in the reference sequence) so 10% is subtracted from the percent identity score calculated by the FASTDB program. If the remaining 90 residues were perfectly matched (100% alignment) the final percent identity would be 90% (100% alignment—10% unmatched overhang). In another example, a 90 residue query sequence is compared with a 100 reference sequence, except that the deletions are internal deletions. In this case the percent identity calculated by FASTDB is not manually corrected, since there are no residues at the N- or C-termini of the subject sequence that are not matched/aligned with the query. In still another example, a 110 amino acid query sequence is aligned with a 100 residue reference sequence to determine percent identity. The addition in the query occurs at the N-terminus of the query sequence and therefore, the FASTDB alignment may not show a match/alignment of the first 10 residues at the N-terminus. If the remaining 100 amino acid residues of the query sequence have 95% identity to the entire length of the reference sequence, the N-terminal addition of the query would be ignored and the percent identity of the query to the reference sequence would be 95%.

The present invention provides methods of visualizing plant root structure in non-transparent or non-translucent soil by providing a root cell of a plant that expresses a first luminescent protein gene operably linked to a constitutive promoter. The luminescence of the first luminescent protein is detected, and an image of the plant root structure in the non-transparent or non-translucent soil is generated based upon the detected luminescence of the first luminescent protein. In these embodiments, only one luminescent protein is necessary to elucidate the structure of the plant root in the soil. In one embodiment, the first luminescent protein is under the control of a constitutive promoter. In another embodiment, the plant root cell(s) contain a second reporter protein and this second reporter protein may be a fluorescent protein or a luminescent protein and it may or may not be under the control of a constitutive promoter, or it may or may not be under the control of an inducible promoter.

The invention also provides methods and systems for visualizing plant root associations with organisms such as bur not limited to bacteria, fungi and animals present in the soil environment. For example the organism might be parasitic, symbiotic or commensal. Examples of such organisms include but are not limited to bacteria, fungi or animals that can be engineered to express a luminescent or fluorescent protein that would permit its visualization and/or distribution in the soil of the systems and vessels described herein. In turn, expression of a different luminescent or fluroescent protein in the plant root cell and subsequent co-cultivation of the plant root cell with the organism allows the spatiotemporal visualization of the root together with the organism. In this embodiment, the plant root structure and the host transgenic organism have been engineered to express at least one luminescent protein, with the other reporter being a luminescent protein or a fluorescent. If only one luminescent protein is used, the luminescence from the first reporter can stimulate fluorescence in the second reporter through a BRET reaction.

Standard methods can be employed in the embodiments where the organism is engineered to express at least one luminescent protein. The expression constructs and methods are well known for a variety of host organisms and one of skill in the art would be able to readily prepare and utilize a typical expression system for use in the appropriate host organism. For example, if a bacterium is used in the methods, a bacterial expression system will be used to express a luminescent protein in the host organism.

Examples of prokaryotic host phyla that could be studied using the methods and systems disclosed herein include but are not limited to Actinobacteria including Streptomycetaceae, Proteobacteria, Firmicutes, Alphaproteobacteria including Rhizobiaceae, Methylobacteriaceae, Gammaproteobacteria including Pseudomonadaceae, Moraxellaceae, Cyanobacteria, Verrucomicrobia, Betaproteobacteria.

Prokaryotic orders included but are not limited to Gemmatimonadetes, Bacteroidetes including Flavobacteriaceae, and Sphingobacteriales.

Prokaryotic families include but are not limited to Comamonadaceae, Bradyrhizobiaceae, Flayobacteriaceae, Micromonosporaceae Bradyrhizobiaceae, Brucellaceae, Hyphomicrobiaceae, Methylobacteriaceae, Phyllobacteriaceae, Rhizobiaceae, Sinorhizobium, Burkholderiaceae, Oxalobateraceae.

Prokaryotic genera and species include but are not limited to Actinocorallia sp., Pseudomonas stutzeri, Azoarcus sp., Bacillus thuringiensis, Burkholderia spp., Pseudomonas putida, Bradyrhizobium elkanii, Bacillus subtilis, Bacillus amyloliquefaciens, Acetobacter diasotrophicus, Kiebsiella pneomoniae, Agrobacterium tumefaciens, Rhizobium, Azorhizobium caulinadans, Azospirillumbrasilense, Serratia spp., Corynebacterium fiavescens, Bacillus purrillus, Sinorhizobium melilotl, Gluconacetobacter diazotrophicus, Herbaspirillum seropedicae, Azospirillumbrasliensis, Herbaspirillum rubrisubalbicans, Firmicutes, Rhizobium rosettiformans, G. diazotrophicus, Herbaspirillum seropedicae, Rhizobiales, Xylella spp., Xylella fastidosa, Salmonella enterica, Botrytis, Azospirilium sp., Methylobacterium populi, Stenotrophomonas maltophilia, Serratia proteornaculons, Pectobacterium atrosepticum, Pseudomonas fluorescens, Psuedomonas brassicacearum, Mesorhizobium.

Fungi and Oomycetes include but are not limited to Arbuscular mycorrhizal fungi, members of the Order Glomales, Alternaria alternate, Leptosphaeria maculans, Thielaviopsis basicola, Verticillium dahlia, Magnaporthe grisea, Plasmodiophora brassicae, Aphanomyces euteiches

Nematodes included but are not limited to Heterodera glycines, Heterodera avenae, Heterodera schachtii, Heterodera trifolii, Heterodera cajani, Heterodera goettingiana, Meloidogyne hapla, Meloidogyne incognita, Meloidogyne arenariaas, Ditylenchus dipsaci, Xyphinema sp., Pratylenchus penetrans, Globodera rostochiensis.

The invention also provides methods and systems for visualizing the distribution and/or interaction of an organism with soil. In one embodiment, a host organism is generated to express a luminescent protein as described herein and in the art, and the host organisms are placed in the vessels of the present invention. A plant root structure may or may not be placed into the vessels with the transgenic host organisms. In one embodiment, the host transgenic organism is placed into the vessels of the present invention with a plant root structure. In a further embodiment, the plant root structure is not genetically modified to express a luminescent protein. In another embodiment, the host transgenic organism is placed into the vessels of the present invention without a plant root structure.

In the embodiments in which organisms in soil are being studied, the organisms' response to virtually any stimulus can be studied. For example, the soil within the vessels of the present invention can be designed and distributed containing of nutrients, water, toxins, etc., and the soil systems can also be designed to create concentration gradients of nutrients, water, salinity, heavy metals, organic compounds, hormones, plant derived substances, bacterial derived substances, fungal derived substances, animal derived substances or toxins, etc. For example, different soil compositions with varying levels of toxins can be prepare and placed in multiple vessels of the present invention, and host organisms expressing at least one luminescent protein can be place in the various soils. Visualizing, monitoring and tracking the host organisms through their luminescence in the systems provided herein would provide insight as to how these organisms would respond to the toxins placed in the soil.

Likewise, the methods and systems of the present invention can be used to screen compounds for their effects on plant root cells and/or organisms in soil. For example, the methods and systems can be used to prepare soils with a compound suspected of being a toxin to the soil organism, e.g., a nematode. An engineered nematode expressing at least one luminescent protein can then be placed into the systems with the test compound and the organism's response to the test compound can be monitored through tracking its fluorescence. Similarly, the methods and systems can be used to prepare soils with a compound suspected of being a nutrient to the plant. A host plant expressing at least one luminescent protein can then be placed into the systems with the test compound and the plant's response to the test compound can be monitored through tracking the fluorescence of the root structure.

The invention is not limited by the methods of detecting and/or visualizing the luminescent protein(s) being expressed in the root plant cells and/or host organisms in the soil. Examples of detecting the reporter constructs includes, but is not limited to, the unaided eye, scintillation counters and low light CCD cameras that can detect thousands of photons of light to name a few.

The following examples are illustrative and are not intended to limit the scope of the invention described herein.

### EXAMPLES

### Example 1

### Design and Implementation of GLO-Roots, a High Resolution Root Growth and Imaging Platform to Quantitate Root System Dynamics in Soil

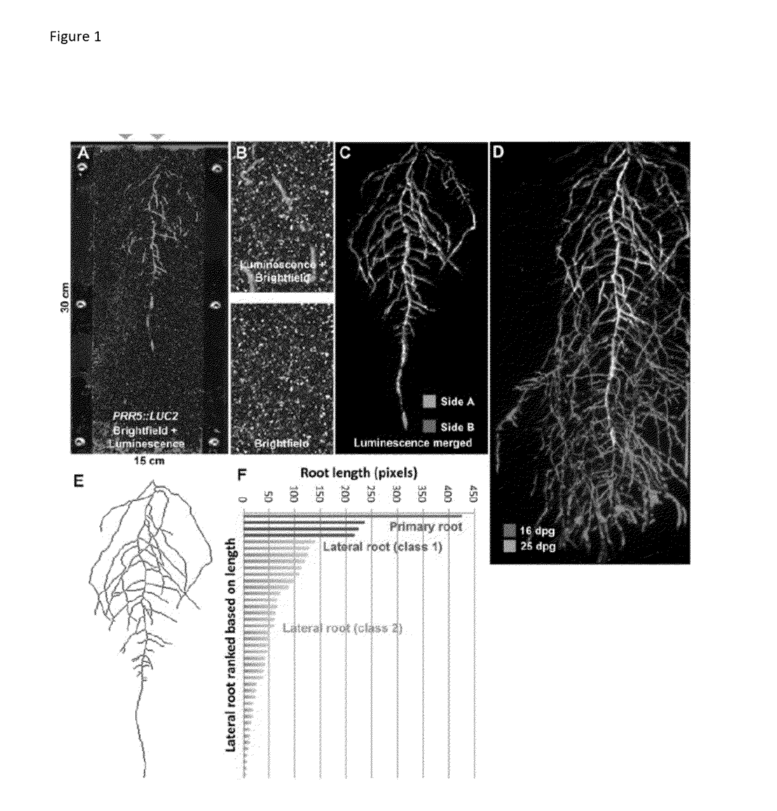

Sheets of polycarbonate plastic were used to create thin chambers (2 mm in thickness), which were filled with soil (FIG. 1A). These chambers were placed in a container that shields light from the root system, but permits illumination of the shoot and transpiration to occur normally. Water supply was controlled by computer and moisture of the soil monitored using a capacitance sensor, or such parameters can also be controlled manually.

To visualize the root system, Arabidopsis thaliana plants were engineered to constitutively express Luciferase (LUC), a reporter protein that emits light when the substrate D-luciferin is added. These plants contained the GLO-Roots system using a PRR5::LUC2 reporter line, which was strongly expressed in the root. Luminescence was measured on both sides of the rhizotron (dubbed side A and B) and a composite image was constructed. These data indicate a surprising level of detail in the root system that was revealed and enable visualization of primary, secondary and tertiary roots.

The GLO-Roots system may also utilize gene synthesis to generate an Arabidopsis codon-optimized version of LUC2, which will increase translation efficiency in plant cells. Use of known constitutive promoters such as 35Sp or UBIQUITIN10p can select for plants that show uniformly strong and stable expression in the root system.

Imaging of roots was performed with an IVIS luminescence imaging system. Images can be taken, for example, once every 2 days over the life span of the plant, including during the reproductive phase. The total life cycle of Arabidopsis is about 8 weeks and this provides an opportunity to understand the transition between vegetative and reproductive growth affects the root system.

The growth of roots in the vessels of the present invention (rhizotrons) allowed for the root system parameters to be determined in 2 dimensions, simplifying the analysis and modeling of the data. Computer vision algorithms may also be used to quantify imaging data. Various geometrical attributes of the root system may also be determined and used to identify traits that have greater power in correctly classifying root systems of plants grown under different conditions (Iyer-Pascuzzi, A. S., Symonova, O., Mileyko, Y., Hao, Y., Belcher, H., Harer, J., Weitz, J. S. and Benfey, P. N. (2010) ‘Imaging and analysis platform for automatic phenotyping and trait ranking of plant root systems’, Plant Physiology 152(3): 1148-57; Clark, R. T., MacCurdy, R. B., Jung, J. K., Shaff, J. E., McCouch, S. R., Aneshansley, D. J. and Kochian, L. V. (2011) ‘Three-dimensional root phenotyping with a novel imaging and software platform’, Plant Physiology 156(2): 455-65). Current imaging quality allows a number of root system architecture (RSA) traits to be quantified manually or through the implementation of available software packages such as Image) and ROOTrace (FIG. 1D, E) (Abramoff, M. D., Magelhaes, P. J. and Ram, S. J. (2004) ‘Image Processing with Image)’, Biophotonics International 11(7): 36-42; French, A., Ubeda-Tomas, S., Holman, T. J., Bennett, M. J. and Pridmore, T. (2009) ‘High-throughput quantification of root growth using a novel image-analysis tool’, Plant Physiology 150(4): 1784-95; Naeem, A., French, A. P., Wells, D. M. and Pridmore, T. P. (2011) ‘High-throughput feature counting and measurement of roots’, Bioinformatics 27(9): 1337-8).

### Example 2

### Generation and Analysis of Developmental and Physiological Reporters for Molecular Phenotyping of the Root System in Soil

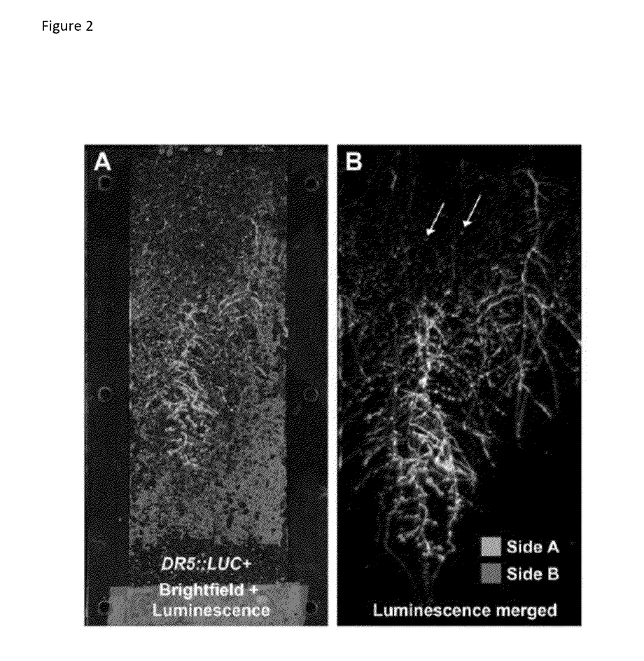

The development of a phenotyping platform based on LUC expression has the advantage that other non-constitutive promoters can be used as well. For example, the regulatory regions of genes involved in osmotic stress response (e.g. RD29Ap) (Yamaguchi-Shinozaki, K. and Shinozaki, K. (1993) ‘Characterization of the expression of a desiccation-responsive rd29 gene of Arabidopsis thaliana and analysis of its promoter in transgenic plants’, Mol Gen Genet 236(2-3): 331-40), nitrate response (e.g. 4xNREp) (Konishi, M. and Yanagisawa, S. (2011) ‘Roles of the transcriptional regulation mediated by the nitrate-responsive cis-element in higher plants’, Biochemical and biophysical research communications 411(4): 708-13), bacterial elicitor response (e.g. CYP71A12p) (Millet, Y. A., Danna, C. H., Clay, N. K., Songnuan, W., Simon, M. D., Werck-Reichhart, D. and Ausubel, F. M. (2010) ‘Innate immune responses activated in Arabidopsis roots by microbe-associated molecular patterns’, The Plant cell 22(3): 973-90) or other physiological processes can be used to design LUC reporters to track this biological information at the spatiotemporal level. In addition, regulatory sequences controlled by hormonal signals such as auxin (DR5p) (Ulmasov, T., Murfett, J., Hagen, G. and Guilfoyle, T. J. (1997) ‘Aux/IAA proteins repress expression of reporter genes containing natural and highly active synthetic auxin response elements’, The Plant cell 9(11): 1963-71) and ABA (RAB18p) (Lang, V. and Palva, E. T. (1992) ‘The expression of a rab-related gene, ra b18, is induced by abscisic acid during the cold acclimation process of Arabidopsis thaliana (L.) Heynh’, Plant molecular biology 20(5): 951-62) will be selected. Preliminary analysis of the DR5::LUC+reporter, which marks cells exhibiting peak-levels of auxin response (Moreno-Risueno, M. A., Van Norman, J. M., Moreno, A., Zhang, J., Ahnert, S. E. and Benfey, P. N. (2010) ‘Oscillating gene expression determines competence for periodic Arabidopsis root branching’, Science 329(5997): 1306-11), reveals the presence of pre-initiation stage lateral root primordia (FIG. 2). A dual reporter system can be developed to enable visualization of these reporters simultaneously with the root structure. A green light emitting Click Beetle Luciferase (CBG99) and a red-shifted Firefly luciferase (Ppy PE8) can be plant codon-optimized for this purpose. Studies in mice have demonstrated the utility of such dual color reporter systems (Mezzanotte, L., Que, I., Kaijzel, E., Branchini, B., Roda, A. and Lowik, C. (2011) ‘Sensitive dual color in vivo bioluminescence imaging using a new red codon optimized firefly luciferase and a green click beetle luciferase’, PLoS One 6(4): e19277). The present invention thus allows for visualization of the root structure with biological information, whereas other currently available systems, including μCT-based X-ray tomography, are limited to the visualization of root structures alone without being able to overlay other biological information.

### Example 3

### Determining the Relationship between Soil Properties and Root System Architecture

The establishment of the GLO-Roots system may be conducted using a standardized potting mix, PRO-Mix, which contains Sphagnum peat moss, perlite, major- and micronutrients, dolomite and calcitic limestone. In addition, alternative growth media may be used to study the effect of varying soil properties on RSA. Part of these studies may utilize agriculturally relevant soils, such as natural Californian soils, to understand the range of phenotypic variation that occurs in these complex environments. Analysis of RSA features in these soils can help to identify variables that may be of interest for future studies.

Various types of soils may be utilized and varied for content, such as: (1) levels of nutrients, (2) exchangeable acidity, (3) textural class, and (4) organic content. Samples may be collected from various regions for comparison. Soils can also be collected in consultation with local services and organizations, such as, e.g., the National Resources Conservation Services (NRCS) staff in California, and several kg of “plow-depth” soils collected dry, and returned for processing such as mixing, light (<4 mm) sieving, and woody debris removed. Soils may be sterilized, such as through the use of irradiation, before use to reduce the number of variables under investigation.

The soil may be initially quantified for their physical and chemical properties (e.g. soil organic matter, cation-exchange capacity, phosphate-adsorption capacity, moisture-release curves, elemental composition by ICP) using protocols described (Robertson, G. P., Coleman, D. C., Bledsoe, C. S. and Sollins, P. (1999) Standard Soil Methods for Long-Term Ecological Research, New York: Oxford University Press). During each 8-wk growth cycle of Arabidopsis, exchangeable cations/anions, pH and electrical conductivity can be measured by minimal-tension lysimeters for each of the soils. LUC reporters for lateral root primordia (DR5p), acidity (AtALMT1p) (Hoekenga, O. A., Maron, L. G., Pineros, M. A., Cancado, G. M., Shaff, J., Kobayashi, Y., Ryan, P. R., Dong, B., Delhaize, E., Sasaki, T. et al. (2006) ‘AtALMT1, which encodes a malate transporter, is identified as one of several genes critical for aluminum tolerance in Arabidopsis’, Proceedings of the National Academy of Sciences of the United States of America 103(25): 9738-43), osmotic stress (RD29Ap), nitrate response (4xNREp) and phosphate starvation (AtIPS1p) (Martin, A. C., del Pozo, J. C., Iglesias, J., Rubio, V., Solano, R., de La Pena, A., Leyva, A. and Paz-Ares, J. (2000) ‘Influence of cytokinins on the expression of phosphate starvation responsive genes in Arabidopsis’, The Plant journal: for cell and molecular biology 24(5): 559-67) can be analyzed using the dual reporter system in these soils.

In addition, simple synthetic growth substrates composed of constituents with known physical properties may be generated. These studies allow for understanding the influence that these components have on root growth in a more controlled setting. Sandy soils are marked by high drainage rates and poor moisture retention. Sand of varying particle size from 2 mm to 0.25 mm and vary the amount of water that is supplied to the rhizotrons from the bottom to create a moisture gradient can be utilized. Water potential of the substrate can be measured using a psychrometer at different points along the rhizotron. Of interest may be the affect particle size has on the steepness of the moisture gradient and how changes in RSA enable the plant to explore and exploit this environmental heterogeneity. In these experiments, markers for lateral roots (DR5p) and osmotic stress (RD29Ap) to characterize the response of different parts of the root system to changes in water availability can be utilized.

All publications and patent applications herein are incorporated by reference to the same extent as if each individual publication or patent application was specifically and individually indicated to be incorporated by reference. The publications discussed herein are provided solely for their disclosure prior to the filing date of the present application. Nothing herein is to be construed as an admission that the present invention is not entitled to antedate such publication by virtue of prior invention.

What is claimed is:

1. A method for determining how stressors affect plant root growth, the method comprising:
a) expressing in a root cell of a plant a first luminescent protein gene encoded by a first nucleic acid and a second luminescent or fluorescent protein encoded by a second nucleic acid, wherein the first nucleic acid is operably linked to a constitutive promoter and the second nucleic acid is operably linked to an inducible promoter; and
b) contacting the root cell with the stressor,
c) determining the luminescence of the first protein and the luminscence or fluorescence of the second luminescent or fluorescent protein before and after (b),
wherein a change in the luminescence or fluorescence of the second luminescent protein after (b) indicates that the stressor affects expression of the gene of interest.

2. The method of claim 1, wherein the first or second luminescent protein is a luciferase protein.

3. The method of claim 1, wherein the inducible promoter is derived from a gene known to respond to the stressor.

4. The method of claim 1, wherein the inducible promoter is derived from a gene not known to respond to the stressor.

5. The method of claim 1, wherein the stressor is selected from salinity, temperature, water, acidity, alkalinity, heavy metals, soil compaction, microbes, pathogens, insects and nutrients.

6. The method of claim 5, wherein the nutrients are selected from amino acids, sugars, nitrogen, carbon, oxygen, phosphorous, potassium, sodium, sulfur, and zinc.

7. The method of claim 1, wherein the root cell is in a vessel surrounded by soil.

8. The method of claim 7, wherein the soil surrounds the root cell at a thickness of between 0.1 mm to 5 mm.

9. The method of claim 7, wherein the change in luminescence of the second luminescent protein is detected in the soil.

10. The method of claim 7, wherein the luminescence is measured from more than one location of the vessel.

11. The method of claim 7, wherein the luminescence is measured from two opposing sides of the vessel.

12. The method of claim 1, wherein the root cell is from Arabidopsis, Brassica, Glycine, Oryza, Zea, Triticum, Setaria, Panicum, Sorghum or Hordeum.

13. The method of claim 1, wherein the first promoter is selected from the group consisting of 35S, CaMV, UBIQUITIN10, and a G-box.

14. The method of claim 1, wherein the second promoter is selected from the group consisting of RD29A, RAB18, TCH4, ADH1, 4xNRE, CYP71A12, DRS, RAB18, AtALMT1, and AtIPS1.

15. A root cell of a plant comprising a first nucleic acid that encodes a first luminescent protein gene and a second nucleic acid that encodes a second luminescent or fluorescent protein, wherein the first nucleic acid is controlled by a constitutive promoter and the second nucleic acid is controlled by a promoter of a gene of interest.

16. A vessel configured to allow growth of a plant from an opening and contain a root system of the plant, the vessel comprising two planar opposing transparent or translucent surfaces that are separated by spacers that are between 1 mm to 5 mm thick; a sealed bottom surface; and an opening at the top of the vessel to permit plant growth.

17. A system comprising a
a) root cell of a plant, the root cell comprising a first nucleic acid that encodes a first luminescent protein gene that is operably linked to a promoter, and
b) the vessel of claim 16.

18. The system of claim 17, wherein the root cell further comprises a second nucleic acid that encodes a second luminescent or fluorescent protein that is operably linked to a promoter.

19. The system of claim 18, further comprising a means for detecting or measuring the first and/or second luminescent or fluorescent proteins when expressed and the root cell is surrounded by soil in the vessel.

20. The system of claim 17, wherein the promoters are constitutive promoters or inducible promoters.

21. The system of claim 17, further comprising non-transparent or non-translucent soil.

22. A method for visualizing a plant root structure in non-transparent or non-translucent soil, the method comprising:
a) expressing in a root cell of a plant a first luminescent protein gene encoded by a first nucleic acid that is operably linked to a constitutive promoter, and
b) detecting the luminescence of the first luminescent protein in the non-transparent or non-translucent soil, and
generating an image of the plant root structure in the non-transparent or non-translucent soil based upon the detected luminescence of the first luminescent protein.

23. The method of claim 22, further comprising expressing a second luminescent or fluorescent protein encoded by a second nucleic acid that is operably linked to an inducible promoter

24. The method of claim 22, wherein the first or second luminescent protein is a luciferase protein.

25. A method of determining the interaction of an organism with a plant root, the method comprising
a) planting a plant in a soil, the plant comprising a first reporter protein and the soil comprising a genetically engineered organism, wherein the genetically engineered organism comprises a second reporter protein, and
b) determining the signal from of the first and/or second reporter proteins,
wherein determining the signal of the first and second reporter proteins allows for determination of the interaction between the genetically engineered organism and the plant root structure.

26. The method of claim 25, wherein the first reporter protein is a luminescent protein.

27. The method of claim 26, wherein the second reporter protein is a luminescent or fluorescent protein.

28. The method of claim 25, wherein the second reporter protein is a luminescent protein.

29. The method of claim 28, wherein the first reporter protein is a luminescent or fluorescent protein.
